(19) United States
(12) Patent Application Publication
(10) Pub. No.: US 2019/0040996 A1
(43) Pub. Date: Feb. 7, 2019

(54) LUBRICATION SYSTEM INCLUDING AN ENERGY-GENERATING ELEMENT

(71) Applicant: SKF Lubrication Systems Germany GmbH, Walldorf (DE)

(72) Inventors: Juergen Kreutzkaemper, Waibstadt-Daisbach (DE); Holger Schmidt, Klein-Machnow (DE); Andreas Schoenfeld, Sankt Leon-Rot (DE)

(21) Appl. No.: 16/027,416

(22) Filed: Jul. 5, 2018

(30) Foreign Application Priority Data
Aug. 4, 2017 (DE) 102017213588.3

(51) Int. Cl. F16N 7/38; F16N 13/22; F16N 13/06; F16N 29/02; F16N 29/04; H02N 2/18; H02J 7/00; H01F 7/06; H01F 7/02

(52) U.S. Cl. CPC F16N 7/38; F16N 13/22; F16N 13/06; F16N 29/02; F16N 29/04; H02J 7/345; H02J 7/0052; H01F 7/06; H01F 7/0231; F16N 2270/20; F16N 2260/20; H02N 2/18

(57) ABSTRACT

A lubrication system for supplying a lubricant to at least one lubrication point includes at least one lubricant line and at least one lubricant system component that is connected to the lubricant line. The lubrication system component includes at least one movable element and/or the lubricant line includes at least one movable portion. The system also includes at least one energy-generating element, such as a piezo element or a magnet and coil, configured to interact with the at least one movable element and generate energy from a movement of the at least one moveable element.

### CROSS-REFERENCE

This application claims priority to German patent application no. 10 2017 213 588.3 filed on Aug. 4, 2017, the contents of which are fully incorporated herein by reference.

### TECHNOLOGICAL FIELD

The present disclosure relates to a lubrication system for supplying at least one lubrication point with lubricant, wherein the lubrication system includes at least one lubricant supply line and at least one lubrication system component that is connected to the lubricant line.

### BACKGROUND

Diverse lubrication systems are known from the prior art, using which lubricant is delivered to points to be lubricated, for example, to bearings. Here the lubrication system usually comprises a lubricant pump, for example, a piston pump, and a lubricant distributor device, wherein lubricant pump and lubricant distributor device are connected to each other via a lubricant line. The lubricant distributor device in turn interacts with the points to be lubricated and usually supplies the points to be lubricated with a metered amount of lubricant.

Furthermore, a variety of sensors are disposed in the lubrication system, which sensors control, monitor, or examine the operation of the lubricant pump, the temperature, and the quantity of the lubricant pumped or also the viscosity of the lubricant. These and other components of the lubrication system, such as, for example, sensors or valves, require energy, which is usually provided via batteries provided in the lubrication system or a central power supply.

These known energy supplies require either a plurality of installed batteries, which have a very large space requirement, or a plurality of cables, which must also extend in the lubrication system, which on the one hand is expensive and on the other hand is complex in terms of construction technology.

### SUMMARY

An aspect of the present disclosure is therefore to improve the known energy supply in the lubrication system.

In the following a lubrication system is proposed for supplying at least one lubrication point with lubricant, wherein the lubrication system includes at least one lubricant supply line and at least one lubrication system component, which are connected to each other.

In this context a “lubrication system component” is understood to mean all elements installable into the lubrication system and all components functionally associated with the lubrication system. For example, a lubrication system component can be a lubricant pumping device such as, for example, a lubricant pump, or a lubricant distributor, such as, for example, a progressive distributor, single-line, double-line, or multi-line distributor, or also a lubricant metering system, such as, for example, a flow limiter, or a metering unit, or a valve generally. Furthermore, a lubrication system component can also be a sensor or a monitoring unit, such as, for example, a pressure switch or similar. These sensors or monitoring units can be provided directly in the lubrication system as independent elements; however, it is also possible for a sensor or a monitoring unit to be formed integrally with one of the lubrication system components. These sensors or monitoring units usually control, monitor, or examine detection variables in the lubrication system, such as, for example, pressure, temperature, quantity, or viscosity of the pumped lubricant.

Furthermore a lubrication system component can also be a communication device, such as, for example, a signal transmission device, using which, for example, detection variables detected by the sensors are provided to a control device or an operator, or received from the control device or the operator.

Thus in the following a device that can both receive and send signals, or only send signals, or only receive signals is subsumed under the term “signal transmission device.”

It is common to all of these lubrication system components that they must be supplied with energy.

The inventors have furthermore recognized that a variety of lubrication system components furthermore include moving elements, such as, for example, pistons, and that the often pulsating pumping of lubricant represents in itself a movement in the lubrication system. According to the disclosure this movement can be used to generate energy with the help of energy-generating elements that interact with the moving element, which energy can in turn be used in the lubrication system or by the components of the lubrication system. This component can be, for example, a component built directly into the lubrication system, such as a to-be-powered valve; however, using the generated energy it is also possible to power components functionally associated with the lubrication system, for example, sensors, such as, for example, a temperature sensor or a vibration sensor, or a signal transmission device, which, for example, communicates the detection variables detected by the sensor to a control device or user.

Here the moving element can advantageously be a piston or associated with a piston, and/or be a membrane or associated with a membrane. Alternatively or additionally it can also be an elastically expanding or contracting hose of a lubricant line, which hose uses the pulsating movement with the pumping of the lubricant.

According to one advantageous exemplary embodiment the energy-generating element is a piezo element or an inductive element. Here the piezo element generates electrical energy in the event of a deforming, which energy can be provided via the moving element, while the inductive element provides a generating of current using coils that are moved relative to one another. The piezo element is mountable at a location where it will be subjected to changing pressure, caused by the movement of a piston, for example, such that pressure is applied against and then released from the piezo element as the piston moves. Alternately, the piezo element can be mounted behind a membrane in the wall of a chamber such that the membrane flexes with pressure changes and presses against the piezo element. As a further alternative, the piezo element can be mounted adjacent a lubrication line so that the expansion and contraction of the lubrication line presses against the piezo element. When an inductive element is used as the energy generating element, for example, a magnet could be mounted on a piston and a coil mounted outside the piston cylinder such that the movement of the magnet with the piston generates a current in the adjacent coil. The current produced by the piezo element or the inductive element can be used to charge a battery or a capacitor or to directly power an element of the lubrication system.

As mentioned above an energy consumer can be a sensor element that is predestined for a supplying of energy by energy-generating element, since sensors must be installed at many points of the lubrication system, which points are often difficult to access, or wherein an installation space for an additional battery is not available.

Here the energy supply can be designed such that, due to the energy-supply element, the sensor element is altogether capable of detecting at least one detection variable, in particular a property of the lubrication system. However, it is also possible to supply only a part of the sensor, for example, a sensing element of the signal transmission device, with energy. Here, the energy-generating element can interact with the sensor element such that the detection variable is continuously monitored or detected; however, it is also possible to detect the detection variable discontinuously, e.g., only under certain conditions or at certain times.

Furthermore, at least one energy storage unit can be associated with the energy-generating element, in which energy storage unit energy from the energy-generating element is storable. This energy storage unit is advantageous in particular when only little energy, or insufficient energy for a continuous supplying of the element to be supplied with energy, can be provided. An energy storage unit is also advantageous when the element consuming the energy need only be supplied with energy from time to time. Such an energy storage unit is advantageously, for example, a rechargeable battery.

According to a further advantageous exemplary embodiment the energy storage device is connected to at least one lubrication system component and/or to at least one sensor element in order to supply the lubrication system component and/or the sensor element with energy.

In addition to sensor elements, signal transmission devices are preferred in particular as energy consumers. Thus the lubrication system includes at least one signal transmission device that is configured to wirelessly transmit or receive a signal provided by a lubrication system component, wherein the signal transmission device is supplied with energy using the energy generated by the energy-generating device. Components that need not be electrically driven themselves but transmit the detection variables to a central control unit and/or are to receive from them are usually equipped with signal transmission devices that must be powered. Specifically for these devices a separate battery or a connection to a central power supply can be possible; however, this requires a further cabling or a providing of installation space, which enlarges and complicates the lubrication system. Due to the supplying of energy using the energy-generating element the signals detected in the system can be simply transmitted to a central control unit without additional installation space or a complex cabling having to be provided.

Here the signal transmission device can transmit the signals continuously or discontinuously to a control unit or receive them from it. For example, a signal detected by the sensor unit is transmitted by the signal transmission device, wherein the signal transmission device and/or the sensor element are supplied with energy by the energy-generating element.

Further advantages and advantageous embodiments are specified in the description, the drawings, and the claims. Here in particular the combinations of features specified in the description and in the drawings are purely exemplary, so that the features can also be present individually or combined in other ways.

In the following the disclosure is described in more detail using the exemplary embodiments depicted in the drawings. Here the exemplary embodiments and the combinations shown in the exemplary embodiments are purely exemplary and are not intended to define the scope of the disclosure. This scope is defined solely by the appended claims.

### BRIEF DESCRIPTION OF THE DRAWING

FIG. 1 shows a schematic depiction of a first preferred exemplary embodiment of an inventive lubrication system.

### DETAILED DESCRIPTION

In the following, identical or functionally equivalent elements are designated by the same reference numbers.

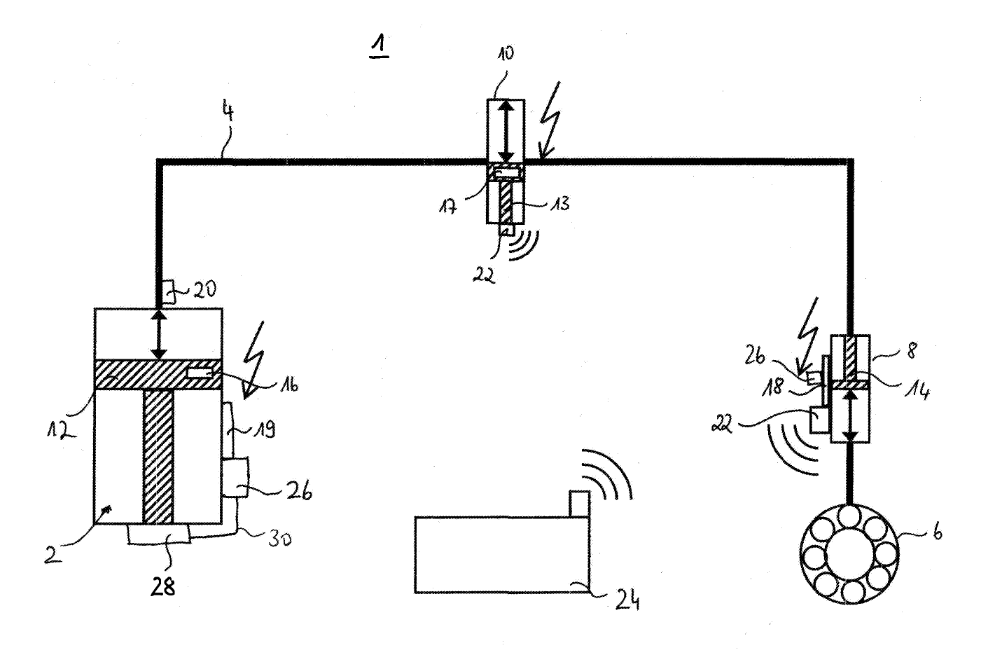

FIG. 1 schematically shows a lubrication system 1 including a lubricant pumping device 2 that is connected to a lubricant line 4 in order to pump lubricant to a to-be-lubricated point 6 that is depicted here as a bearing. In order to deliver a precisely metered amount of lubricant or distribute lubricant generally onto the bearing, a lubricant distributor device 8 is furthermore provided that is disposed upstream of the bearing 6. The lubricant distributor device can be, for example, a single-line distributor or progressive distributor. As can be further seen from FIG. 1, a sensor unit 10 is further provided on the lubricant line 4, which sensor unit 10, for example, monitors a lubricant flow through the line 4, or its temperature or viscosity. In the exemplary embodiment depicted in FIG. 1 the sensor unit 10 is a pressure switch that measures the pressure of the lubricant transported in the lubricant line 4.

As furthermore schematically depicted in FIG. 1 the lubricant pumping device 2, the lubricant distributor device 8, or the sensor unit includes pistons 12, 13, 14 that ensure a distributing or pumping or metering of lubricant. These pistons 12, 13, 14 represent, for example, moving elements. The moving elements, here the pistons 12, 13, 14, furthermore interact with energy-generating elements 16, 17, 18, 19, wherein an inductive element 18 is schematically disposed on the lubricant distributor element, while a piezo element 16, 17 is provided on the lubricant pumping device 2 and on the sensor 10. Here the components 2, 4, 8, 10 of the lubrication system not only include a type of energy-generating element; rather, it is also possible, as shown, for example, in the lubricant pumping device 2, to provide different energy generating elements 16, 19 on a component. Thus, for example, an inductive energy-generating element 19 can further be provided on the lubricant pumping device 2.

These energy-generating elements 16, 17, 18, 19 act in a known manner, wherein the piezo elements 16, 17 obtain electrical energy from a deforming of the element, while the inductive elements 18, 19 generate current via two coils moved with respect to each other. These energy-generating elements interact with the moving elements in order to generate energy that is provided for use in the lubrication system 1. The energy generation is illustrated by the symbol for current.

This energy can be provided, for example, to a sensor element 20 attached to one of the components, so that this sensor element 20 is capable of capturing, detecting, or monitoring a detection variable. Alternatively or additionally the energy can also be provided, for example, to a signal transmission device 22 that is configured in the illustrated exemplary embodiment as wireless signal transmission device 22. Using this wireless signal transmission device 22 a detection variable, for example, of the sensor 10 can be transmitted to a remotely disposed control device 24 or to a remotely disposed user. Alternatively or additionally a signal can also be issued by the control device 24, which signal, for example, is received by the signal transmission device 22 of the lubricant distributor device 8 in order to control the amount of lubricant to be dispensed on the bearing 6.

Furthermore, an energy storage unit 26 can be provided in the lubrication system 1, which energy storage unit 26, for example, interacts with the energy-generating element 18 or 19 in order to store energy for a later or energy-intensive application. Thus, for example, an emergency power supply for a motor 28 of the lubricant pumping device 2 can be provided via the stored energy. The energy transfer can be effected, for example, using a cabling 30.

Overall, using the inventive lubrication system a largely self-sufficient lubrication system can be provided whose individual and often difficult-to-access components can be supplied directly with self-generated energy. Since a variety of elements including moving parts are present in lubrication systems, there is sufficient possibility to generate energy using, for example, piezo elements or inductive elements. For example, it is also possible to design the lubricant line at least sectionally from an elastic material such that with pulsating pressure, surges of the lubricant guided through the lubricant line an elastic expanding and contracting of the lubricant line is generated, which in turn represents a moving element that interacts with an energy-generating element. In particular the usually pulsating lubricant pumping in lubrication systems thus already represents a movement in itself that can be used for generating energy.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved lubrication systems.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Lubrication system
2 Lubricant pumping device
4 Lubricant line
6 To-be-lubricated point
8 Lubricant distributor device
10 Integrated sensor unit
12, 13, 14 Pistons
16, 17, 18, 19 Energy-generating element
20 Functionally associated sensor
22 Signal transmission device
24 Control device
26 Energy storage unit
28 Motor
30 Cable

What is claimed is:

1. A lubrication system for supplying a lubricant to at least one lubrication point, the lubrication system comprising:
at least one lubricant line, and
at least one lubricant system component that is connected to the lubricant line,
wherein the lubrication system component includes at least one movable element and/or the lubricant line includes at least one movable portion,
further including at least one energy-generating element configured to interact with the at least one movable element and generate a current from a movement of the at least one moveable element.

2. The lubrication system according to claim 1,
wherein the lubrication system component is a lubricant pump or a lubricant distributor or a lubrication monitoring device or a valve.

3. The lubrication system according to claim 1, wherein the lubrication system component includes the at least one movable element, wherein the at least one moveable element comprises a piston, and wherein the at least one energy-generating element is acted upon by a pressure generated by a movement of the piston.

4. The lubrication system according to claim 1, wherein the energy-generating element is configured to provide energy for operating the at least one lubrication system component.

5. The lubrication system according to claim 1, wherein the lubrication line includes the at least one movable portion and wherein the at least one movable portion is an elastically expandable and contractable hose of the lubricant line.

6. The lubrication system according to claim 1, wherein the energy-generating element is a piezo element

7. The lubrication system according to claim 1, wherein the energy-generating element is an inductive element.

8. The lubrication system according to claim 1, furthermore including at least one sensor element configured to receive energy generated by the energy-generating element.

9. The lubrication system according to claim 8, wherein the energy-generating element is configured to supply the at least one sensor element with energy such that the sensor element is capable of detecting at least one detection variable.

10. The lubrication system according to claim 1,
further including a signal transmission device configured to wirelessly transmit and/or to receive a signal provided by a lubrication system component,
wherein the signal transmission device is supplied with energy from the energy-generating element; and/or
wherein the lubrication system includes at least one sensor element, and the at least one sensor element includes a signal transmission device that is configured to wirelessly transmit a signal detected by the sensor element, wherein the signal transmission device is supplied with energy by the energy generated by the energy-generating element.

11. The lubrication system according to claim 1, further comprising at least one energy storage device that is associated with the energy-generating element and is configured to store the energy generated by the energy-generating element.

12. The lubrication system according to claim 11, wherein the energy storage device is connected to at least one lubrication system component and/or to at least one sensor element in order to supply the lubrication system component and/or the sensor element with energy.

13. A lubrication system for supplying a lubricant to at least one lubrication point, the lubrication system comprising:
at least one lubricant line, and
at least one lubricant system component that is connected to the lubricant line,
wherein the lubrication system component includes a piston and/or the lubricant line includes a movable portion,
further including a piezo element positioned relative to the piston such that a pressure generated by a movement of the piston generates a voltage across the piezo element or positioned relative to the moveable portion such that a movement of the movable portion generates the voltage across the piezo element.

14. The lubrication system according to claim 13 including a battery or a capacitor operatively connected to the piezo element for storing energy generated by the piezo element.

15. The lubrication system according to claim 14, including a signal transmission device electrically connected to the battery or to the capacitor.

16. A lubrication system for supplying a lubricant to at least one lubrication point, the lubrication system comprising:
at least one lubricant line, and
at least one lubricant system component that is connected to the lubricant line, the lubrication system component including a piston,
further including a magnet connected to the piston for movement with the piston and a coil mounted adjacent the piston such that movement of the a piston induces a current in the coil.

17. The lubrication system according to claim 16 including a battery or a capacitor operatively connected to the coil for storing energy generated by the magnet and the coil.

18. The lubrication system according to claim 17, including a signal transmission device electrically connected to the battery or to the capacitor.
